(19) United States
(12) Patent Application Publication
(10) Pub. No.: US 2003/0193107 A1
(43) Pub. Date: Oct. 16, 2003

(54) Method for manufacturing animal chew toy

(76) Inventor: Charles A. Byrne, Mammoth Lakes, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/414,630

(22) Filed: Apr. 15, 2003

Related U.S. Application Data
(60) Provisional application No. 60/372,849, filed on Apr. 16, 2002.

(51) Int. Cl. B29C 47/06; B32B 31/00

(52) U.S. Cl. 264/148; 264/171.1; 264/173.12; 264/173.15; 264/173.16; 264/320; 264/326

(57) ABSTRACT

A method for manufacturing an animal chew toy includes providing a rubber material, such as tire rubber, and then forming the rubber material into a predetermined chew toy configuration, such as a tire. Preferably, a scent is added to the rubber material. Synthetic fibers, such as nylon or polyester fibers, are embedded in the rubber material.

### RELATED APPLICATION

This application claims priority from U.S. Provisional Application Serial No. 60/372,849, filed Apr. 16, 2002.

### BACKGROUND OF THE INVENTION

The present invention generally relates to animal chew toys. More particularly, the present invention relates to a method for manufacturing animal chew toys comprised of scented rubber having nylon material embedded therein. Dogs inherently enjoy the need to chew. Dogs need chew toys for teething as puppies and general chewing as the dogs mature.

Currently, there are many rubber dog toys of various shapes made from solid rubber using standard compression molding processes, or cast molded from vinyl. Animal chew toy products made from plastic such as nylon or vinyl are too hard. However, such products made from natural rubber are not very durable and must continually be replaced. Very few animal chew toys provide any health benefits to the animal.

A real tire dog chew toy developed by CB Worldwide is made from die-cutting tire sidewalls into various shapes, such as bones, etc. Although dogs like to chew on tires, it has been found that the tires include metal beads or wires within the rubber of the tires which can be harmful to a dog if bitten.

Accordingly, there is a need for a chew toy which is durable and provides a health benefit to the animal. The present invention fulfills these needs and provides other related advantages.

### SUMMARY OF THE INVENTION

The present invention resides in a method for manufacturing an animal chew toy which is comprised of a durable material but which is pliable and soft enough for an animal, such as a dog, to chew. The animal chew toy of the present invention also includes synthetic fibers which serve as a health benefit to the animal. Moreover the animal chew toy of the present invention may include a scent which masks the otherwise unpleasant odor of the material of the chew toy.

The method for manufacturing the animal chew toy in accordance with the present invention comprises the steps of providing a rubber material. Preferably, the rubber material comprises a tire rubber material composed of natural or synthetic rubber mixed with carbon black.

Synthetic fibers, such as nylon or polyester fibers, are embedded in the rubber material. Such fibers provide strength and also serve as a tooth floss for the animal. Such embedding can be performed by forming the rubber material into sheets, and rolling two sheets of rubber onto opposite sides of a layer of the synthetic fibers.

The rubber material is then formed into a pre-determined chew toy configuration. This may be done by cutting the sheets of rubber material into strips, after which the strips are formed into the predetermined chew toy configuration. In a particularly preferred embodiment, the animal chew toy has a tire configuration. This configuration is created by placing the rubber strips over a rigid frame to form a mold blank structure, and then compression molding the mold structure to create the animal chew toy.

The tire rubber animal chew toys of the present invention may have a scent added thereto for masking any unpleasant smell of the tire rubber to the animal.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a diagrammatic view of scent being added to a rubber material used in accordance with the present invention, and formed into sheets embedded with synthetic fibers, and cut into strips for manufacturing the animal chew toys of the present invention;

FIG. 2 is a perspective view of a strip of the rubber material of the present invention wrapped around a rigid cylindrical mold;

FIG. 3 is a perspective view of the strip of rubber material of FIG. 2 formed into a cylindrical structure;

FIG. 4 is a perspective view of the cylindrical strip of FIG. 3 placed on a forming device used in accordance with the present invention;

FIG. 5 is a perspective view of the formed rubber material placed within a compression mold;

FIG. 6 is a perspective view of an animal chew toy having a tire configuration after the compression molding and disposed in a base of the mold; and

FIG. 7 is a perspective view of the completed animal chew toy having the tire configuration.

### DETAILED DESCRIPTION OF THE PREFERRED EMBODIMENTS

The present invention resides in a method for manufacturing animal chew toys which are more durable than prior soft rubber toys, yet not harmful to the mouth of the animal. It has been found that tire rubber is very durable, yet soft enough for a dog to chew. It has also been found that rubber can be reinforced with synthetic fibers, which also serves to floss the teeth and gums of the dog or other animal chewing on the toy.

The present invention will be described as a particular method for creating a chew toy having a tire configuration. However, any chew toy comprised of durable tire rubber and reinforced with synthetic fibers are intended to be within the scope of the present invention.

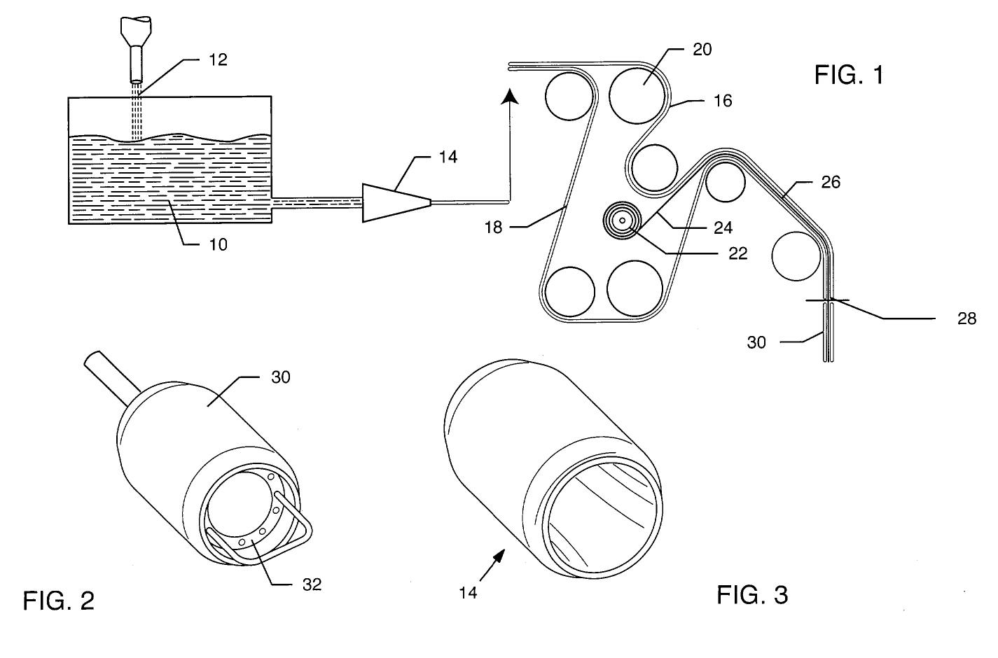

With reference now to FIG. 1, in a particularly preferred embodiment of the present invention, a source of rubber material 10 is provided. Typically, the rubber material 10 comprises tire rubber material which is composed of natural or synthetic rubber mixed with carbon black, as is well-known in the art. Typical tire rubber has a unique and strong smell which might deter some dogs from using the chew toys created by the rubber 10. Accordingly, in a particularly preferred embodiment, a scent 12 is added to the rubber material 10. It has been found that a lavender/mint scent sufficiently masks the strong odor of the rubber material 10 and is pleasant to the animal. The rubber material 10 is sent through an extruder 14 which forms thin sheets 16 and 18 of rubber material. Rollers 20 may be used to create and handle the sheets 16 and 18 of rubber material.

Synthetic fiber 22 is embedded into the sheets 16 and 18 of rubber material. Typically, the two layers 16 and 18 of rubber material are rolled using rollers 20 onto a layer 24 of either two-ply or four-ply nylon or polyester, to create a single sheet 26 of rubber material embedded with the synthetic fiber 22. This sheet 26 is then cut 28 into individual strips 30 of appropriate dimension for forming the chew toy.

With reference now to FIGS. 2 and 3, the strip 30 is placed around a rigid form 32, typically comprised of metal. The result is a generally cylindrical structure 34 of rubber material, as illustrated in FIG. 3.

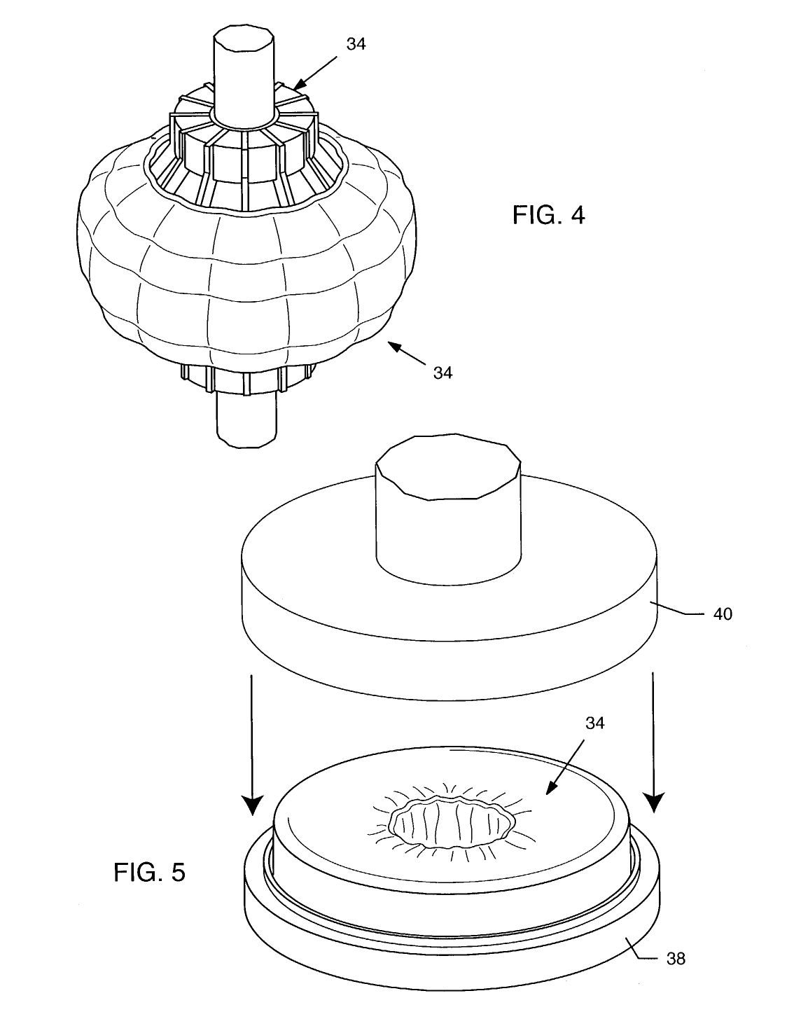

With reference now to FIG. 4, the generally cylindrical rubber material structure 34 is placed on a fixture 36 which is capable of expanding and forming the cylindrical structure 34 into an initial, rough tire shape. The now donut or tire-shaped member 34 is removed from the expansion fixture 36 and inserted into a base 38 of a compression mold, comprised of the base 38 and upper member 40, with any additional inserts or the like as is well-known in the compression molding art. The rubber tire form 34 is then compression-molded into the predetermined chew toy configuration.

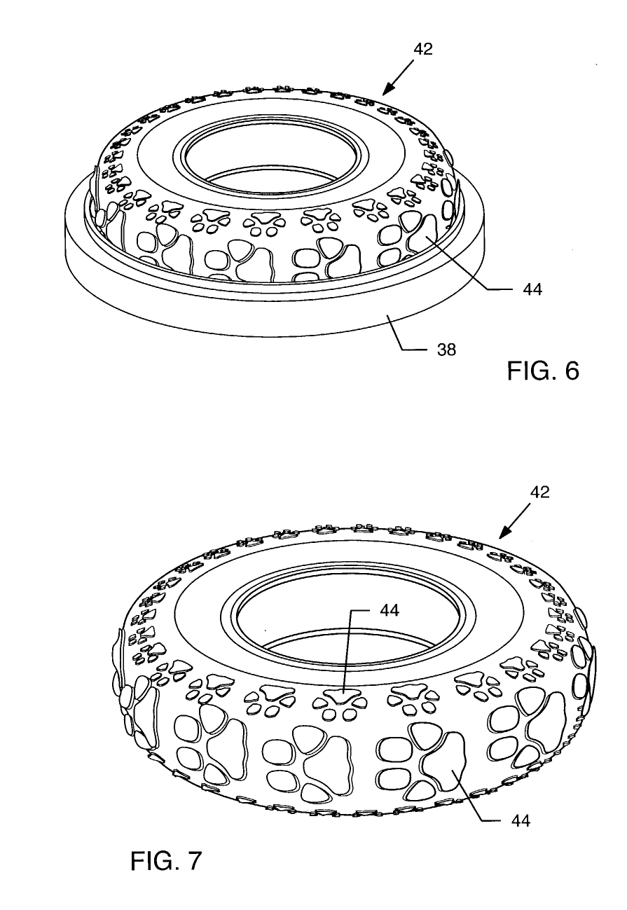

With reference to FIGS. 6 and 7, in a particularly preferred embodiment, the chew toy 42 is of a small tire configuration, typically ranging in size from six to ten inches in diameter. Such sizes have been found to be optimal as dogs of different sizes can bite onto a sidewall thereof, and carry the chew toy 42 or move it easily. For decoration purposes, a paw print 44 design may be formed on the tire chew toy as the tread. Other than its small size and optional unique tire tread design, the chew toy 42 appears very similar to an automobile tire. However, the chew toy 42 does not include the metal beads or wires of traditional automobile tires which can cause injury to the gums, tongue, etc. of the dog. Instead, the synthetic fibers 22 embedded within the chew toy 42 actually serve to floss and clean the teeth and gums of the animal chewing the toy 42.

Such small sized tire toys 42 can be used as retrieval toys as these are easily rolled or thrown by the dog's owner, and can be grasped and retrieved by the dog. The tire chew toys 42 can be produced in a black rubber, to simulate a real tire, or other colors, such as red, can be injected into the rubber material 10 to provide a very bright and attractive appearance to the dog. Cotton rope can be attached to the chew toy 42 for added chewing, and user dog-tugging; or buoyant foam can be added to the inside of the tire toy 42 so that the toy can be used as a floating chew toy and retriever.

It will be appreciated by those skilled in the art that the scented rubber material 10 and 12, or reinforced sheet 26 of rubber material can be advantageously formed into a variety of different chew toy configurations. Thus, although the manufacture of a chew toy 42 having a tire configuration has been described in detail, the steps of the present invention can be modified as needed to create other chew toy configurations.

Although several embodiments have been described in detail for purposes of illustration, various modifications may be made without departing from the scope and spirit of the invention. Accordingly, the invention is not to be limited, except as by the appended claims.

What is claimed is:

1. A method for manufacturing an animal chew toy, comprising the steps of:
providing a rubber material;
embedding synthetic fibers in the rubber material; and
forming the rubber material into a predetermined chew toy configuration.

2. The method of claim 1, wherein the rubber material comprises a tire rubber material.

3. The method of claim 2, wherein the tire rubber material comprises natural or synthetic rubber mixed with carbon black.

4. The method of claim 1, wherein the embedding step comprises embedding nylon or polyester fibers into the rubber material.

5. The method of claim 1, including the step of forming the rubber material into sheets.

6. The method of claim 5, wherein the embedding step comprises the step of rolling two sheets of rubber onto a layer of synthetic fibers.

7. The method of claim 5, including the step of cutting the sheets of rubber material into strips, after which the strips are formed into the predetermined chew toy configuration.

8. The method of claim 7, wherein the forming step comprises the steps of placing the rubber strips over a rigid frame to form a mold blank structure, and then compression molding the mold structure to create the animal chew toy.

9. The method of claim 8, wherein the animal chew toy has a tire configuration.

10. The method of claim 1, including the step of adding a scent to the rubber material.

11. A method for manufacturing an animal chew toy, comprising the steps of:
providing a tire rubber material comprising natural or synthetic rubber and carbon black;
embedding synthetic fibers in the rubber material; and
forming the rubber material into a predetermined chew toy configuration.

12. The method of claim 11, wherein the embedding step comprises embedding nylon or polyester fibers into the rubber material.

13. The method of claim 11, including the steps of forming the rubber material into sheets and rolling two sheets of rubber onto a layer of synthetic fibers to embed the fibers in the rubber material.

14. The method of claim 13, including the step of cutting the sheets of rubber material into strips, after which the strips are formed into the predetermined chew toy configuration.

15. The method of claim 14, wherein the forming step comprises the step of placing the rubber strips over a rigid frame and formed into a cylinder structure, and then compression molding the cylinder structure to create a tire configuration.

16. The method of claim 11, including the step of adding a scent to the rubber material.

17. A method for manufacturing an animal chew toy, comprising the steps of:
providing a tire rubber material comprised of natural or synthetic rubber and carbon black;
adding a scent to the rubber material; and
forming the rubber material into a predetermined chew toy configuration.

18. The method of claim 17, including the step of embedding synthetic fibers into the rubber material.

19. The method of claim 18, wherein the embedding step comprises embedding nylon or polyester fibers into the rubber material.

20. The method of claim 18, including the steps of forming the rubber material into sheets and rolling two sheets of rubber onto a layer of the synthetic fibers to embed the fibers in the rubber material.

21. The method of claim 20, including the step of cutting the sheets of rubber material into strips, after which the strips are formed into the predetermined chew toy configuration.

22. The method of claim 21, wherein the forming step comprises the steps of placing the rubber strips over a rigid frame to form a cylinder structure, and then compression molding the cylinder structure to create a tire configuration.
